(19) United States
(12) Patent Application Publication
(10) Pub. No.: US 2022/0259512 A1
(43) Pub. Date: Aug. 18, 2022

(54) METHOD AND SYSTEM FOR OBTAINING COMPONENTS FROM NATURAL GAS

(71) Applicant: Linde GmbH, Pullach (DE)

(72) Inventors: Tobias KELLER, Feldkirchen-Westerham (DE); Christian VOSS, Geretsried (DE); Gabriel SALAZAR DUARTE, München (DE); Stefan PLEINTINGER, Eichendorf (DE); Patrick SCHIFFMANN, München (DE); Verena KRAMER, München (DE)

(21) Appl. No.: 17/597,849

(22) PCT Filed: Sep. 22, 2020
(86) PCT No.: PCT/EP2020/025427

§ 371 Date: Jan. 26, 2022

(30) Foreign Application Priority Data
Sep. 27, 2019 (EP) 19020546.8

(51) Int. Cl. C10L 3/10; B01D 53/22; B01D 53/047

(52) U.S. Cl. CPC C10L 3/101; B01D 53/226; B01D 53/229; B01D 53/047; C10L 3/104; C10L 2290/548; B01D 2256/245; B01D 2257/11; B01D 2257/504; B01D 2257/702; B01D 2253/106

(57) ABSTRACT

The invention relates to a method for obtaining natural gas components, wherein, using natural gas, a feed mixture containing methane and helium is provided and subjected to a separating sequence so as to obtain a natural gas product which is enriched with methane and depleted of helium in comparison to the feed mixture and a helium product which is depleted of methane and enriched with helium in comparison to the feed mixture, which method comprises one or more membrane separating steps and one or more pressure change adsorption steps. According to the invention, the feed mixture is provided using natural gas containing methane, higher hydrocarbons, helium and carbon dioxide, and the providing of the feed mixture comprises depleting the natural gas used for provision of the feed mixture of carbon dioxide and of the higher hydrocarbons. The present invention also relates to a corresponding system.

The present invention relates to a method for obtaining natural gas components and to a corresponding system in accordance with the respective preambles of the independent claims.

### PRIOR ART

Natural gas contains different components, some of which have a higher economic and technical value than natural gas as a mixture. It is, therefore, advantageous to obtain, for example, so-called natural gas liquids (NGL), liquefied gas (LPG), natural gas condensates and optionally pure components, such as methane, ethane, propane and butane, from natural gas, or to fractionate the natural gas for this purpose.

The fractionation of natural gas typically takes place in cryogenic processing plants, which are customized or standardized according to local market and customer requirements. As regards the corresponding processes, reference is made for example to the article entitled “Natural Gas” in Ullmann's Encyclopedia of Industrial Chemistry, online publication 15 Jul. 2006, DOI: 10.1002/14356007.a17_073.pub2.

Methods and systems for obtaining helium from natural gas are also known and are described, for example, in H.-W. Haring (publ.), Industrial Gas Processing, Wiley VCH, 2006, in particular chapter 4 entitled “The Noble Gas Helium” or in the article entitled “Noble Gases” in Ullmann's Encyclopedia of Industrial Chemistry, online publication 15 Mar. 2001, DOI: 10.1002/14356007.a10_045.pub2. Cryogenic, membrane-based and combined methods and systems are known.

US 2017/0320736 A1 and EP 3 034 466 B1 disclose a method for obtaining helium from a process gas. The process gas is supplied at a pressure of less than 15 bar to a first membrane separation stage having a first membrane which is more easily permeable to helium than to at least one other component in the process gas. A first retentate stream is supplied to a second membrane separation stage having a second membrane which is more easily permeable to helium than for at least one other component in the process gas. Helium is separated from a permeate stream of the first membrane separation stage by means of pressure swing adsorption in order to obtain a helium-containing product stream. A helium-containing permeate stream of the second membrane separation stage is supplied to the first membrane separation stage. A purge gas from pressure swing adsorption is also recycled to the first membrane separation stage.

To fractionate natural gas, a compression and acid gas removal can be initially carried out after a first condensation step to obtain heavy condensates. After dehydration, cooling to cryogenic temperatures and treatment in a deethanizer can then take place to remove ethane and lower boiling components. The remaining residue can be treated in a depropanizer in order to remove propane. After the removal of propane, the butane isomers can be separated from the remaining residue in a debutanizer. The remaining residue is combined with the heavy condensates formed in the first condensation step. Variants of the method just described differ in particular in the sequence of the individual steps and in the formation of the respective fractions.

The fractionation of natural gas and the recovery of helium from natural gas are usually complicated and cost-intensive due to the cryogenic temperatures used. There is, therefore, a need for improved processes and systems for fractionating natural gas and for obtaining certain components from natural gas.

### DISCLOSURE OF THE INVENTION

Against this background, the present invention proposes a method for obtaining components from natural gas and a corresponding system having the features of the respective independent claims. Advantageous embodiments of the invention are the subject matter of the dependent claims and the description below.

The present invention is described below predominantly with reference to natural gas as the starting gas, but is generally also suitable for processing other gas mixtures, for example biogas or gas mixtures with nitrogen as the main component.

The present invention proposes an altogether advantageous process for obtaining natural gas components, including, in particular, helium, which works completely non-cryogenically during the actual helium recovery and the recovery of some other components. The term “non-cryogenic” recovery here is understood to mean a recovery which is carried out completely at a temperature level of above 0° C., in particular above −50° C. or above −100° C. The non-cryogenic recovery makes it possible to dispense with otherwise required expensive, high-maintenance and complex cryogenic components. The process proposed according to the invention is also extremely flexible due to the at least partially non-cryogenic process control.

In the context of the present invention, in particular the removal of heavier hydrocarbons to be described below, i.e., hydrocarbons with two and more, in particular three and more, for example two, three, four, five and six carbon atoms, can also be carried out non-cryogenically, and using an adsorbent, in an adsorption process.

A corresponding adsorption process can be carried out, for example, using three or more adsorption vessels. An adsorbent based on silica gel can be used as adsorption agent. This technique is, however, more likely to separate hydrocarbons with a carbon number of six and more; the separation of hydrocarbons with two and three carbon atoms or their removal from the natural gas is more complex.

To explain the features and advantages of the present invention, the terms “permeate,” “retentate,” “adsorbate” and “non-adsorbate” are used, which are to be understood in the manner explained below.

In the context of the present application, a “permeate” is understood to mean a gas mixture which predominantly or exclusively comprises components of a gas mixture (separation feed) supplied to the membrane separating step, which are not retained or are likely to be not retained by a membrane used in a membrane separating step, which thus pass through the membrane more easily than others. In the context of the invention, membranes are used in particular which retain methane more strongly than helium. In this way, the permeate is enriched in helium. A corresponding membrane is, for example, a commercial polymer membrane which can be used on an industrial scale for separating corresponding components. A permeate can be taken from a membrane separation unit used in the membrane separating step on the side of the membrane other than that on which the separation feed is supplied to the membrane separation unit.

Accordingly, a “retentate” is a gas mixture predominantly comprising components that are retained completely or at least predominantly by the membrane used in the membrane separating step. The retentate considered within the scope of the present invention is in particular enriched in methane and depleted of helium. The retentate can be taken from a membrane separation unit used in the membrane separating step on the same side of the membrane on which the separation feed is supplied to the membrane separation unit.

An “adsorbate” comprises those components which, in a pressure swing adsorption in an adsorption step, adsorb to an adsorbent under higher pressure and are released from it in a desorption step at a lower pressure. The desorption step is the step which is initiated under pressure reduction after partial or complete saturation of an adsorbent used. The adsorbate is thus enriched in the components adsorbing in the adsorption step to the adsorbent, here methane in comparison to helium.

Accordingly, a “non-adsorbate” is the gas mixture which flows past or through the adsorbent in the adsorption step and is led out of the adsorption unit. The non-adsorbate is thus enriched in the non-adsorbing components, here helium in comparison to methane.

Overall, the present invention proposes a method for obtaining natural gas components in which, using natural gas, a feed mixture containing methane and helium is provided and subjected to a separating sequence to obtain a natural gas product enriched in methane and depleted of helium in comparison to the feed mixture and a helium product depleted of methane and enriched in helium in comparison to the feed mixture, which separating sequence comprises one or more membrane separating steps and one or more pressure swing adsorption steps.

If the text below refers to “depletion,” this is understood here to mean also, and in particular, the (substantially) complete removal of corresponding components, i.e., a “depletion to zero” or to a tolerable residual content or to trace components.

According to the invention, the feed mixture is provided using natural gas that contains methane, higher hydrocarbons, helium and carbon dioxide, and the provision of the feed mixture comprises depleting the natural gas, which is used for provision of the feed mixture, of carbon dioxide and of the higher hydrocarbons. The feed mixture can be depleted of the higher hydrocarbons such that the hydrocarbon dew point at an operating pressure of, for example, approx. 10 to 150 bar (abs.) is less than −10° C. and the (residual) content of carbon dioxide is less than 2 vol %. The methane content may account for the predominant amount of the remaining residue, for example 96 to 99 or up to 99.9 mol %. The natural gas used for provision of the feed mixture can, for example, have a hydrocarbon dew point of more than −10° C. at the operating pressure. The content of carbon dioxide can be, for example, more than 50 vppm (ppm in the volume fraction) and the content of helium can be, for example, more than 50 vppm. The natural gas used for provision of the feed mixture can comprise further acid gases, water and the like, which can be removed in a suitable manner when the feed mixture is provided.

The higher hydrocarbons can be removed, in particular non-cryogenically in the manner addressed above and explained below, whereas the removal of carbon dioxide can be precipitated in particular by suitable washing processes (amine washes). A sufficiently compressed natural gas can be subjected to Joule-Thomson expansion for cold production, in particular for removing the higher hydrocarbons. The higher hydrocarbons can be removed in particular also by using an oil wash.

In detail, a temperature swing adsorption step can be used in the context of the present invention to remove the higher hydrocarbons, as proposed in U.S. Pat. No. 5,557,030 A, US 2013/0291723 A1, WO 2014/021900 A1 or DE 10 2006 011 031 A1.

Where activated carbon is used as an adsorbent in such processes, hydrocarbons having five and more carbon atoms can be removed almost completely. However, there may be strong fluctuations in the calorific value of the purified natural gas since the next shorter hydrocarbon in comparison to the hydrocarbon to be completely removed is completely retained at the beginning of each adsorption cycle and then returned to the natural gas in a relatively short time as a peak during regeneration. These high fluctuations are generally not acceptable for feeding into a natural gas pipeline, but can be used within the scope of the invention. If silica gel is used as adsorbent, as in one embodiment of the invention, hydrocarbons having six and more carbon atoms can be removed effectively.

According to WO 2015/116793 A1, natural gas can also be subjected to an oil wash for removing corresponding hydrocarbons, for example. In this technology, the higher hydrocarbons contained in the natural gas are absorbed by means of oil. The washing oil may consist of a short-chain or long-chain hydrocarbon. The use of a long-chain washing oil with a relatively low vapor pressure has the advantage that relatively little washing oil is lost to the gas to be purified; however, a relatively large amount of energy must be expended during regeneration by means of boiling. If a short-chain washing oil with a relatively high vapor pressure is used, this disadvantage is eliminated, but more thereof may transition to the gas phase, so that a relatively large amount of fresh oil must be provided.

Thermal processes in which heavy hydrocarbons are condensed out by direct cooling of the with the aid of a refrigerant are also known. This technology is very robust, but typically does not allow a sharp separation of individual hydrocarbon fractions.

In other method variants, the natural gas can be isenthalpically expanded from high pressure to low pressure via a regulator, whereby it cools down. As in the case of direct cooling, only the dew point of the gas can be set. High pressure differences are required to achieve low dew points.

Higher hydrocarbons can be separated from the natural gas also by using rubber-like membranes.

Although complete and selective separation of individual hydrocarbon fractions typically cannot be achieved with this technology, separation can still be sufficient.

The removed hydrocarbons can be obtained in a corresponding product fraction and used in any way. The correspondingly obtained carbon dioxide can also be used for suitable purposes, for example for the beverage industry or for tertiary oil recovery.

In a particularly preferred embodiment of the present invention, the natural gas used for provision of the feed mixture is withdrawn from an external natural gas source at a pressure level of 10 to 150 bar (abs.) or optionally more (natural gas may leak from gas deposits even at 200 to 500 bar) and is not further compressed upstream of the one or more membrane separating steps. In this embodiment, compression is, therefore, not part of the method according to the invention. Although reference is made here mainly to the processing of natural gas or the recovery of natural gas components, the method according to the invention is also suitable for other gas mixtures, as mentioned, which are suitably composed, especially if they are provided under a corresponding pressure.

In the context of the present invention, the natural gas used for provision of the feed mixture has in particular more than 0.5 vol % carbon dioxide. It thus differs fundamentally from the gas mixture used, for example, in EP 3 034 466 B1 mentioned in the introduction.

The method according to the invention comprises in particular a two-stage membrane separation with subsequent pressure swing adsorption; it is thus a method in which the separating sequence comprises a first membrane separating step, a second membrane separating step and a pressure swing adsorption step, wherein in the first membrane separating step a first retentate and a first permeate are formed, in the second membrane separating step a second retentate and a second permeate are formed, and in the pressure swing adsorption step a non-adsorbate and an adsorbate are formed. The membrane separating steps serve in particular to deplete the gas mixture of methane such that residual methane can be separated off in the pressure swing adsorption step.

Advantageously, in the context of the present invention at least some of the adsorbate and at least some of the second permeate together with the feed mixture are supplied to the first membrane separating step. Advantageously, some of the first retentate is furthermore supplied to the second membrane separating step, at least some of the first permeate is supplied to the pressure swing adsorption step, at least some of the second retentate is used to provide the natural gas product, and at least some of the non-adsorbate is used to provide the helium product.

The first retentate can comprise in particular 50 to 99 percent of the methane and 0.1 to 10 percent of the helium, which is supplied to the first membrane separating step in a gas mixture, here in the form of the feed mixture, the second permeate and the adsorbate, or in each case parts thereof. Accordingly, the first permeate can comprise in particular up to 80 percent of the methane and more than 20 percent of the helium, which is supplied to the first membrane separating step. Unless stated otherwise, the percentages given here and hereinafter denote in particular percent by volume.

The second retentate can comprise in particular 10 to 99.999 percent of the methane and 10 to 10,000 vppm of the helium, which is supplied to the second membrane separating step in a gas mixture, here in the form of the first retentate or a part thereof. Accordingly, the second permeate can comprise in particular up to 95 percent of the methane and more than 5 percent of the helium, which is supplied to the second membrane separating step. The non-adsorbate can comprise in particular up to 1 percent of the methane and more than 99.999 percent of the helium, which is supplied to the pressure swing adsorption step in a gas mixture, here in the form of the first permeate or a part thereof. Accordingly, the adsorbate can comprise in particular more than 30 percent of the methane and up to 70 percent of the helium, which is supplied to the pressure swing adsorption step.

In particular, the first retentate can comprise 10 to 99 percent methane and 1 to 5 percent helium, the first permeate can comprise more than 30 percent helium, the second retentate can comprise 10 to 99 percent methane and 100 to 1000 vppm helium, the second permeate can comprise up to 70 percent methane and 10 to 30 percent helium, the non-adsorbate can comprise 1 to 10 ppmv methane and 99.99 to 99.9999 percent helium and the adsorbate can comprise 70 to 90 percent methane and 10 to 20 percent helium.

It should be emphasized only for further clarification that membranes having a higher permeability to helium than to methane are used in the first and in the second membrane separating steps, and that an adsorbent having a higher affinity for methane than for helium is used in the pressure swing adsorption step.

The pressure swing adsorption step is advantageously operated at an adsorption pressure level of 6 to 20 bar (abs.) and a desorption pressure level of less than 0.5 bar (rel.), wherein the non-adsorbate is provided at the adsorption pressure level and the adsorbate is provided at the desorption pressure level.

In one embodiment of the invention, the second permeate is provided at a permeate pressure level of, in particular, less than 0.5 bar (rel.) bar, and the first membrane separating step is operated at an inlet pressure level which is above the desorption pressure level and permeate pressure level of the second permeate, wherein the adsorbate or the portion of the adsorbate, which is supplied together with the feed mixture to the first membrane separating step, and the second permeate or the portion of the second permeate, which is supplied together with the feed mixture to the first membrane separating step, are compressed to the inlet pressure level of the first membrane separating step.

In the context of the present invention, the inlet pressure into the first and second membrane separating steps is in particular 10 to 150 bar (abs.).

Significant differences between two method variants result in particular in the sequence of the depletion of higher hydrocarbons and natural gas within the scope of the present invention. In particular, the natural gas used for provision of the feed mixture is either first depleted of carbon dioxide and then of the higher hydrocarbons or first depleted of the higher hydrocarbons and then of carbon dioxide.

The invention also relates to a system for obtaining natural gas components which is configured to provide a feed mixture containing methane and helium using natural gas, and to subject it to a separating sequence to obtain a natural gas product enriched in methane and depleted of helium in comparison to the feed mixture and a helium product depleted of methane and enriched in helium in comparison to the feed mixture, which separating sequence comprises one or more membrane separating steps and one or more pressure swing adsorption steps.

According to the invention, the system is characterized by means which are configured to provide the feed mixture using natural gas that contains methane, higher hydrocarbons, helium and carbon dioxide, and to provide the feed mixture such that the natural gas used for provision of the feed mixture is depleted of carbon dioxide and of the higher hydrocarbons.

For features and advantages of the system according to the present invention and preferred embodiments thereof, reference is expressly made to the above explanations regarding the method according to the invention and its preferred embodiments. A corresponding system is configured in particular for performing a corresponding method or an embodiment thereof.

The invention is described below with reference to the accompanying drawings, which illustrate preferred embodiments of the present invention.

### BRIEF DESCRIPTION OF THE DRAWINGS

FIG. 1 illustrates an embodiment of the present invention in a simplified schematic representation.

FIG. 2 illustrates an embodiment of the present invention in a simplified schematic representation.

In the figures, components corresponding to one another in terms of their function or structure are indicated by identical reference signs and for the sake of clarity are not explained repeatedly.

### DETAILED DESCRIPTION OF THE DRAWINGS

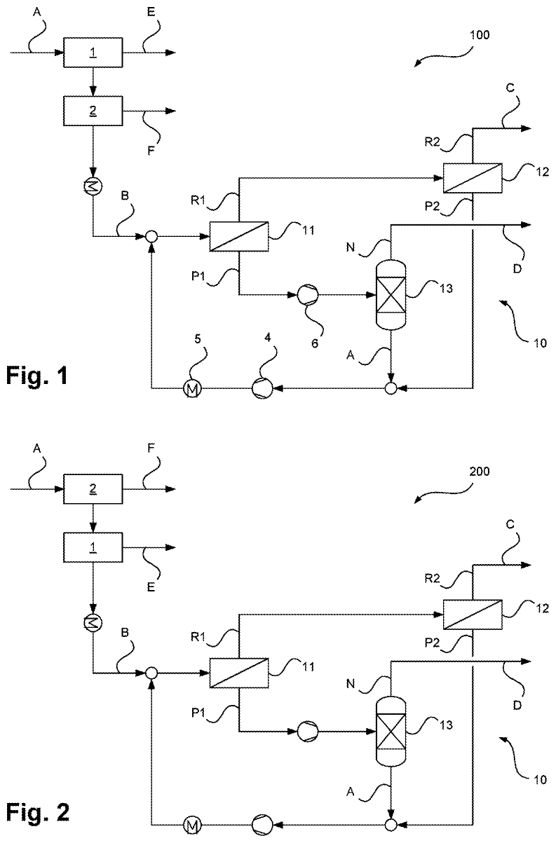

FIGS. 1 and 2 show methods according to preferred embodiments of the present invention in a simplified, schematic representation in the form of simplified process flow diagrams. The following explanations relate to the methods described and to corresponding devices in the same way.

The methods 100, 200 are each used to obtain natural gas components. Using natural gas, which can be provided in the form of a feed stream A and withdrawn, for example, at a suitable pressure level of an external source, such as a tank or a pipeline or a borehole, a feed mixture B comprising methane and helium is provided using method steps that are explained in detail below, and is subjected to a separating sequence designated as a whole with 10 to obtain a natural gas product C enriched in methane and depleted of helium in comparison to the feed mixture and a helium product D depleted of methane and enriched in helium in comparison to the feed mixture.

In the examples illustrated herein, the separating sequence 10 comprises a first membrane separating step 11, a second membrane separating step 12 and a pressure swing adsorption step 13. A first retentate R1 and a first permeate P1 are formed in the first membrane separating step 11, a second retentate R2 and a second permeate P2 are formed in the second membrane separating step 12, and a non-adsorbate N and an adsorbate A are formed in the pressure swing adsorption step 13. Each of them is a gas mixture.

In the illustrated examples, at least some of the adsorbate A and at least some of the second permeate P2 are supplied together with the feed mixture B to the first membrane separating step 11, at least some of the first retentate R1 is supplied to the second membrane separating step 12, at least some of the first permeate P1 is supplied to the pressure swing adsorption step 13, at least some of the second retentate R2 is used to provide the natural gas product C, and at least some of the non-adsorbate N is used to provide the helium product D.

Feed mixture B is provided using natural gas that contains methane, higher hydrocarbons, helium and carbon dioxide. The natural gas stream thus contains these components. The provision of feed mixture B comprises depleting the natural gas A, which is used for provision of the feed mixture, of carbon dioxide in a method step 1 and depleting said natural gas A of the higher hydrocarbons in the manner explained above in a method step 2. As apparent from the combination of FIGS. 1 and 2, the difference between the methods 100 and 200 is in particular the sequence of method steps 1 and 2. A carbon dioxide stream E is formed in method step 1, while a stream F with heavier hydrocarbons is formed in method step 2.

As illustrated here, the feed mixture can be cooled by means of a heat exchanger 3 before it is combined with the recycled second permeate P2 and the adsorbate A. The latter material streams can be compressed together by means of a compressor 4 and cooled by means of a heat exchanger 5. A compressor 6 is provided for compressing the first permeate P1.

1-10. (canceled)

11. A method for obtaining natural gas components, wherein, using natural gas, a feed mixture containing methane and helium is provided and subjected to a separating sequence so as to obtain a natural gas product which is enriched in methane and depleted of helium in comparison to the feed mixture and a helium product which is depleted of methane and enriched in helium in comparison to the feed mixture, which separating sequence comprises one or more membrane separating steps and one or more pressure swing adsorption steps, wherein the feed mixture is provided using natural gas that contains methane, higher hydrocarbons, helium and carbon dioxide and that the provision of the feed mixture comprises depleting the natural gas used for provision of the feed mixture of carbon dioxide and of the higher hydrocarbons.

12. The method according to claim 11, wherein the natural gas used for provision of the feed mixture is withdrawn from an external natural gas source at a pressure level of 10 to 150 bar (abs.) and is not further compressed upstream of the one or more membrane separating steps.

13. The method according to claim 11, wherein the natural gas used for provision of the feed mixture comprises more than 0.5 vol % carbon dioxide.

14. The method according to claim 11, wherein the separating sequence comprises a first membrane separating step, a second membrane separating step and a pressure swing adsorption step, wherein a first retentate and a first permeate are formed in the first membrane separating step, a second retentate and a second permeate are formed in the second membrane separating step and a non-adsorbate and an adsorbate are formed in the pressure swing adsorption step.

15. The method according to claim 14, wherein at least some of the adsorbate and at least some of the second permeate together with the feed mixture are supplied to the first membrane separating step, wherein at least some of the first retentate is supplied to the second membrane separating step, wherein at least some of the first permeate is supplied to the pressure swing adsorption step, wherein at least some of the second retentate is used to provide the natural gas product, and wherein at least some of the non-adsorbate is used to provide the helium product.

16. The method according to claim 15, wherein membranes are used in the first and in the second membrane separating step which have a higher permeability to helium than to methane, and wherein in the pressure swing adsorption step has an adsorbent which has a higher affinity for methane than for helium.

17. The method according to claim 15, wherein the pressure swing adsorption step is operated at an adsorption pressure level of 6 to 20 bar (abs.) and a desorption pressure level of less than 0.5 bar (rel.), wherein the non-adsorbate is provided at the adsorption pressure level and the adsorbate is provided at the desorption pressure level.

18. The method according to claim 15, wherein the second permeate is provided at a permeate pressure level and the first membrane separating step is operated at an inlet pressure level which is above the desorption pressure level and the permeate pressure level of the second permeate, wherein the adsorbate or the portion of the adsorbate that is supplied together with the feed mixture to the first membrane separating step, and the second permeate or the portion of the second permeate that is supplied together with the feed mixture to the first membrane separating step, are compressed to the inlet pressure level of the first membrane separating step.

19. The method according to claim 11, wherein the natural gas used for provision of the feed mixture is first depleted of carbon dioxide and then of the higher hydrocarbons or is first depleted of the higher hydrocarbons and then of carbon dioxide.

20. A system for obtaining natural gas components which is configured to provide a feed mixture containing methane and helium using natural gas, and to subject it to a separating sequence to obtain a natural gas product enriched in methane and depleted of helium in comparison to the feed mixture and a helium product depleted of methane and enriched in helium in comparison to the feed mixture, which separating sequence comprises one or more membrane separating steps and one or more pressure swing adsorption steps, wherein means configured to provide the feed mixture using natural gas that contains methane, higher hydrocarbons, helium and carbon dioxide, and to provide the feed mixture such that the natural gas used for provision of the feed mixture is depleted of carbon dioxide and of the higher hydrocarbons.
